(19) United States
(12) Patent Application Publication
(10) Pub. No.: US 2026/0208204 A1
(43) Pub. Date: Jul. 23, 2026

(54) MODULAR PROCESSING PLANT

(71) Applicant: Owens-Brockway Glass Container Inc., Perrysburg, OH (US)

(72) Inventor: Philipp Zippe, Wertheim (DE)

(21) Appl. No.: 19/137,458

(22) PCT Filed: Dec. 12, 2022
(86) PCT No.: PCT/US2022/052545

§ 371 Date: Jun. 10, 2025

(51) Int. Cl. B03B 9/06

(52) U.S. Cl. CPC B03B 9/06

(57) ABSTRACT

A processing system for the preparation of a mixture of old glass that includes at least one collection module in which the mixture of old glass can be supplied to the processing systems, at least one ferrous metal module, in which ferrous metals can be removed, at least one preliminary separation module, in which light materials and rough components can be removed, at least one scanning module, in which solid materials can be removed, at least one classification module, in which the mixture of old glass can be separated into various groups, at least one crushing module, in which the components of the mixture of old glass can be reduced, at least one granulate separation module, in which ceramic, stone and/or porcelain components can be removed, and at least one metal removal module, in which metals can be removed.

### BACKGROUND

The present disclosure regards a processing system for the preparation of old glass according to the terminology of claim 1.

The collection of used glass as old glass and its recycling as a material is well known. To avoid waste and save energy, the collected and prepared old glass will be melted as part of the recycling of the material and added at least in part to the molten glass when creating glassware.

Of course, the preparation of old glass is relatively intensive, since the mixture of old glass may contain undesirable materials, for one thing and may not have been properly sorted during collection at the level required for recycling. For that reason, a preliminary process in a processing system is usually necessary for the removal of undesirable components and the separation of types of glass so that a mixture of suitably cleaned old glass can be provided for recycling.

The conventional processing systems for the preparation of a mixture of old glass include various sorting, classification and separation devices that remove undesirable solid materials from the mixture of old glass and can sort it according to size and color, in addition to the glass return system. The various devices and functional components for the conventional processing systems for the preparation of a mixture of old glass are thereby connected to each other by conveyor equipment in order to convey the raw materials and the mixture accordingly.

The conventional processing systems involve large systems that have been designed as individual systems and are then built by the respective users through the use of specialists and local installation companies. This individual design of the large systems for the processing of old glass has a number of disadvantages. In addition to the excessive design efforts, a number of installation companies that are unfamiliar with the construction of the system on site must be used, which can lead to significant problems caused by the multitude of interfaces. Aside from that, the conventional processing systems are hardly flexible, which means that high throughput and continuously high availability of a large quantity of old glass is required in order to be able to operate the conventional large systems for the processing of old glass. Correspondingly, the implementation of modifications or extensions is extremely difficult for these large-design systems. Also, the conventional processing systems cannot be pre-mounted so that installation on site is excessively expensive at the construction sites, which are often in rural locations. One further disadvantage to the conventional systems is that they regularly make disassembly and re-assembly at another location impossible.

In addition, steel support construction is typically necessary for the similar processing systems in order to ensure the required stability.

Creating the static equilibrium for the individually designed large systems is exceptionally demanding, subject to errors and significantly restricts flexibility. The necessary design, calculations for the static equilibrium and the increased on-site assembly effort furthermore lead to extensive time periods between the start of the design and the activation of the processing system.

### SUMMARY OF THE DISCLOSURE

Starting from this state of the technology, the present disclosure presents a new processing system for the preparation of a mixture of old glass, which will avoid the disadvantages of the previously known state of the technology, In particular, the use of the processing system should be flexible, as free from efforts as possible and easy to setup at the construction location with a useful static construction.

The present disclosure is based on the underlying concept that the processing system will include several modules and at least one moveable frame. This moveable frame will then accept at least one module. In accordance with the present disclosure, at least one collection module, at least one ferrous metals module, at least one preliminary separation module, at least one scanning module, at least one classification module, at least one crushing module, at least one granulate separation module and/or at least one metal removal module will be accepted by the frame. Doing this would allow complex functional components to be accepted as modules in a frame by the processing system and brought to the processing system's installation site pre-assembled, so that fewer of the processing system's complex components would be created immediately on location.

In the scope of the present disclosure, “mixture of old glass” as a term is understood as a mixture of at least used glass that is typically distinguished by color as white, green and brown glass and may be present as shards, whereby the mixture of old glass may contain undesirable contaminants made of metal, stone, ceramics, porcelain or organic materials. In this, the purity of the mixture of glass will be increased as the mixture of glass undergoes more processing steps in the processing system.

In the scope of the present disclosure, “collection module” as a term is understood as a device where the mixture of old gas is surrendered and by means of which the mixture of old glass can be supplied to the processing system. The collection module can be transported by a conveyance vehicle, such as a wheel loader, with the mixture of old glass. Preferably, the collection module will be sent with the mixture of old glass in the form of bulk material. For the acceptance and conveyance of the mixture of old glass, the collection module may have a discharge chute and a conveyor belt and/or a bucket conveyor. Using a bucket conveyor is particularly reasonable, if the mixture of old glass has been pre-sorted and an especially compact structure is desired.

A “ferrous metals module” as a term is understood in the scope of the present disclosure as a component of the processing system, where ferrous metals will be removed from the mixture of old glass as part of the preliminary separation. This ferro-magnetic component from the mixture of old glass can be removed by means of a permanent magnet, for example.

As a term, “preliminary separation module” is understood in the scope of the present disclosure as a device where light materials, especially organic components and other large components will be removed from the old glass mixture. Large components are in essence those components of the mixture of old glass that are not suitable for further processing by the processing system due to their size. These large components can be separated from the remaining mixture of old glass by means of a size sieve. For the removal of light materials, an organic removal device can be beneficially designed for removing light materials from the remaining old glass mixture using exhaust air flow,

As a term, “scanning module” is understood as a device where solid materials can be removed from the mixture of old glass. For example, this may occur through the removal of undesirable contaminants or waste from the mixture of old glass to one or more of the scanning modules manual workstations. The intention for this is that the mixture of old glass will be conveyed along the manual workstations within reach of the people employed at those stations so that the undesirable solid materials can be manually removed.

As a term, “classification module” is understood in the scope of the present disclosure as a device where the mixture of old glass will be separated into various groups. A classification may, for example, be made by means of various sieves. Aside from that, undesirable foreign remnants can be removed or separated in the scope of classification of the mixture of old glass.

A “crushing module” in the scope of the present disclosure is understood as a device where the components of the mixture of old glass will be reduced. Skilled artisans will be familiar with drum crushers for the reduction of mixture of old glass. In the scope of the present disclosure, the use of a dual drum crusher would be preferable, by means of which the size of the components of the mixture of old glass can be defined precisely as a consequence of their reduction.

A “granulate separation module” in the scope of the present disclosure is understood as a device where components made of ceramic, stone and/or porcelain can be removed from the mixture of old glass. Preferably, an optical separation device will be used in the scope of the present disclosure for the removal of components made of ceramic, stone and porcelain, which represent non-transparent contaminants. In addition, the removal of metal components, heat-resistant glass components and lead glass from the mixture of old glass could be considered.

A “metal removal module” as a term is understood in the scope of the present disclosure as a component of the processing system, where non-ferrous metals will be removed from the mixture of old glass as part of the preliminary separation. Non-ferrous metals will preferably be removed by means of an alternating current precipitator in the scope of the present disclosure. The connection of a ferrous metal could be removed in a magnetic drum arranged as part of the metal removal module in addition to the removal of non-ferrous metals. The module accepted by the frame for the processing system could be pre-assembled in this manner at the manufacturing site according to the solution in accordance with the present disclosure and delivered together with the frame to the construction location for the setup of the processing system. The pre-assembly of the functional components that form the overall system will drastically reduce the processing system's interfaces to be connected at the construction site.

Aside from that, the concept of pre-assembling the individual processing system's modules in respectively transportable frames would allow processing systems to be assembled somewhat like a kit. In particular, this would allow the realization of smaller and more flexible processing systems. To the extent that a processing system would no longer be required at a corresponding location after usage for a specific period of time, the processing system can be disassembled and moved to another location in a simple manner by moving the transportable frame.

In addition, the modularity of the system makes it possible to assemble the system with a number of functional components and/or modules in almost any constellation, which would allow particularly flexible modification of the processing system as well as simplify the re-assembly of the processing system at other locations. In addition, the modularity of the processing system would mean that the processing system's complex functional components would not have to assembled completely and/or done on site, but rather could be delivered as modules to the construction site and merely need to be connected there. Ultimately, only the simple components of the processing system (such as conveyance equipment or basic construction measures like the creation of floor plates or the creation of support structures) would have to be done on site, for example. This would result in the ability to build a processing system on site with a minimum of effort and minimal labor from specialists.

Preferably, the processing system would be constructed of at least one collection module, at least one ferrous metals module, at least one preliminary separation module, at least one scanning module, at least one classification module, at least one crushing module, at least one granulate separation module and/or at least one metal removal module will be accepted by at least one frame.

Certain forms of execution of the present disclosure are the objective of the sub-claims.

The inclusion of a label removal module in at least one frame may be useful. As remnants on the old glass, labels and other packaging materials made of paper, metal or plastic are undesirable in the mixture of old glass, because such limit the further processing and melting of the mixture of old glass. In particular, such label remnants make the processes of preliminary and granulated separation and/or classification much more difficult as subsequent steps. Preferably, the remnants of coating will be rubbed off by at least one conveyor paddle, which will cause the friction within the mixture of old glass to remove the adhesive remnants. The removal of dust and/or organic remnants could also be helpful as part of the removal of the labels.

The inclusion of a dust removal module in at least one frame may also be useful. In principle, a centralized or decentralized dusting by a processing system would be considered in principle for mixtures of old glass. However, centralized dusting has proven helpful. Preferably, the dusting module accepted by a frame would be connected by hoses with the devices in the processing system that also create significant amounts of dust. The exhaust air contaminated with dust would be returned to the dusting module, where solid ceramic components would be removed from the gas and the clean air would then be discharged from the dusting module through an exhaust system. Connecting the dusting module with a preliminary separation module is especially preferable, in order to suction the air carrying dust from the separation of the ceramic, stone and/or porcelain components and supply that air to the dusting module.

A color sorting module where the mixture of old glass would be sorted by color could be considered for addition to a frame as well. The recycling rates and the even quality of the product created from the mixture of old glass can be ensured by the separation of the mixture of old glass by color. In particular, the production of white glass places a high requirement on the quality and purity of the mixture of old glass, whereby brown and green glass should also not exceed a certain erroneous color ratio. Exceeding the erroneous color ratio for the requirement could be prevented through the inclusion of a color sorting module. A coloring sorting module equipped with an optical sensor system would be preferable in the scope of the present disclosure. An optical color sorting module would allow reliable sorting of the mixture of old glass by color, which would save resources especially in regard to personnel and time.

Including the color sorting module into the preliminary separation module could be considered, so that ceramic, stone and/or porcelain components as well as sorting of the mixture of old glass by color would be possible in one module. Doing this would have the benefit of reducing the structural space required for the processing system, reducing the interfaces and reducing the assembly and maintenance effort.

In addition, including optical sorting equipment in the preliminary separation module may be useful. The optical removal of ceramic, stone and/or porcelain components from the mixture of old glass would allow reliable removal of the undesirable components from the mixture of old glass independent of personnel. In addition, the optical sorting equipment can be used to remove other undesirable components from the mixture of old glass, such as heat-resistant glass, lead glass or magnetic metal in addition to ceramic, stone and porcelain.

Providing the processing system with two separation modules, whereby the separation modules are arranged after each other in the flow of the mixture of old glass through processing system may also be useful as part of the present disclosure. In other words, this means that at least two separation modules will not operate parallel to each other in the flow of the mixture of old glass materials, but rather that the mixture of old glass would first be supplied to one separation module, where it would be initially sorted, and subsequently the remaining mixture of old glass would be supplied to the one or more additional separation modules. Doing this creates two levels of sorting along the flow of the mixture of old glass materials through the processing system. Thereby, the reliability of the sorting as well as the quality and purity of the mixture of old glass intended for re-melting would be increased. Including a color sorting module with the separation module at each step of sorting is highly preferable, so that separation of the mixture of old glass by color can be done at each step of the sorting process. Separation of the mixture of old glass into three groups (specifically one group of brown and green glass, one group of white glass and a third group of ceramic, stone and porcelain components) by means of a separation module in one of the first steps of sorting is especially preferable. White glass would then ultimately be supplied to the subsequent second sorting step, where it would be subjected to at least one additional separation module due to the increased purity requirements for recycling white glass. During the second sorting step, forgoing the removal of the ceramic, stone and porcelain components could be considered and, ultimately, sorting by color could be done by means of a module included as one of the separation modules in order to remove the remaining green and brown glass from the white glass group after sorting during the first step. A level of purity sufficient for the recycling requirements could be achieved for the white glass group as well as the brown and green glass groups from the mixture of old glass, which could be beneficial.

The quantities in reserve for supplying the mixture of old glass are quite rough, because a processing system may process 20 tons of mixed old glass per hour, for example. These raw quantities are periodically stored independent of the processing system and supplied to the collection module of the processing system in accordance with the present disclosure for processing. Adding a supply system to the collection module may be helpful as a means of supplying mixtures of old glass to the processing system, such that the mixture of old glass can be supplied to the collection module. Installing and pre-assembling the collection module (which is a complex functional component of the processing system) in a frame before transportation to the construction site is the preferred method, while the supply system would be built on site and connected to the collection module. Pre-assembly of the supply system and installing it into a frame is not necessary, because it is a less complex component of the processing system.

Designing the supply system for the supply of old glass mixture as a filling funnel may also be especially useful. Such filling funnels can easily be constructed on site, as plate construction, for example, and connected to the collection module. Arranging the filling funnel above the collection module would be preferable. The ability to fill the filling funnel by means of a conveyance for bulk goods, such as a dump truck or an earthmover is intended.

In principle, the supply system itself is only intended to supply the mixture of old glass to the processing system. To continuously supply mixtures of old glass to the processing system, it would be helpful if a minimal amount of the old glass mixture were to be temporarily stored in the supply system, especially with a filling funnel. In this manner, the filling funnel can be intermittently filled by means of a conveyance machine, while the mixture of old glass is continuously supplied to the processing system. The temporarily stored quantity of old glass mixture would depend on the size of the supply system on the one hand and the throughput of the processing system on the other hand. By doing this, the design can temporarily store the quantity of old glass mixture in the supply system regardless of whether the throughput of the processing system corresponds to 30 minutes, an hour, 2 hours, 3 hours, 4 hours, 5 hours, 6 hours, 7 hours, 8 hours, 9 hours or 10 hours.

Furthermore, orienting the processing system in the direction of at least one storage system for at least one sorted component of the mixture of old glass may be beneficial. As part of the present disclosure, “sorting component” as a term designates a component that is separate in the processing system as part of the preparation of the mixture of old glass. For example, such components could be undesirable materials in the mixture of old glass, like metal, ceramic or porcelain, but could also be the groups of white, green or brown glass intended for recycling. The storage system would preferably be created on site as a simple component of the processing system, not installed in frames and not preassembled for transportation to the processing system's installation location. Preferably, the storage system should be designed as a bunker for the acceptance of the sorted components. One bunker for each component separated from the mixture of old glass would be especially preferable.

Designing the system so that at least one conveyor system would be used to connect the modules may be beneficial as part of the present disclosure. Preferably, a stationary conveyor would be used as the conveyor system. Using a conveyor belt is even more preferable because of the advantages of a long conveyance length, quantity and speed at relatively low motor performance. Installing the conveyor system in to a frame and transporting it pre-assembled to the installation location would be conceivable, however building the conveyor system at the installation location and assembling it on site may be beneficial. The relatively simple construction of the conveyance system can be done by a limited personnel on site so that the transportation costs involved in mounting the conveyor system into a frame and transporting the frame to the installation location for the processing system could be avoided. This approach also reflects the underlying thinking of the processing system in accordance with the present disclosure, specifically that complex functional components should be accepted as modules in a frame by the processing system and brought to the processing system's installation site pre-assembled, so that fewer of the processing system's complex components would be created immediately on location.

Depending on the complexity of the motor system, a motor system could be pre-assembled in a frame and initially connected with additional component parts, such as the belts and framework of the conveyance equipment at the installation location. A motor system could also include a transfer unit for the transfer of at least part of the mixture of old glass to a subsequent processing step and/or include a subsequent component of the processing system in addition to the motor for the conveyor system,

Furthermore, the connection of individual modules in any manner desired by a conveyor system could be considered. However, connecting at least the collection module with the ferrous metals module and/or connecting the ferrous metals module with the preliminary separation module and/or connecting the scanning module with the metal removal module and/or the label removal module and the classification module by means of conveyance systems may be helpful. The modules could also be arranged offset from each within the processing system and long conveyor lengths and quantities could be transported between the modules through the connection by means of a conveyor system.

Designing the frame to be self-supporting also proved to be helpful. Doing so makes the transportation of the frame to the installation location simpler as well as the setup of the processing system at the installation location without supporting construction, for which reason the related steel construction to be setup separately at the installation location could be avoided. Doing this not only reduces the costs for the steel construction itself but also the effort for the creation of a corresponding static equilibrium for the processing system.

During the preparation of the mixture of old glass, the presence of dust can represent an increasing problem, since dust emissions may only be tolerated in very low quantities. For that reason, providing the frame with an enclosing exterior wall, which would prevent dust from penetrating the interior area of the frame would be helpful for solving this problem. Doing so would create a shell around the frame that dust cannot penetrate. To the extent that several frames would be combined in order to form a partial section of the processing system, the frames would only present an exterior wall that cannot be penetrated by dust, which for the exterior skin of the combined frames.

Mounting the processing system in multiple transportable may be beneficial for the simple and quick installation of the processing system at the installation location, because then one or several modules could be installed as the processing system. The pre-assembled modules of the processing system could then be delivered to the construction site at the installation location for the system thanks to the combination of frames and then later be removed from the installation location. Preferably, the cables for the individual frames would already be laid and could be simply plugged together with the other frames and activated. Constructing the processing system from multiple transportable frames would be preferable, whereby at least one frame with a collection module, at least one frame with a ferrous metals modules, at least one frame with a preliminary sieving module, at least one frame with a scanning module at least one frame with a crushing module, at least one frame with a granulated separation modules and at least one frame with a metal removal modules would be the preferable design.

Arranging or stacking the various processing system frames above each other may be yet a further benefit with regard to the saving space in the construction of the processing system and simple flow of the materials within the processing system. To the extent that various frames are arranged or stack above each other, the flow of material can simply be from top to bottom, which is especially preferable alone from the fact of gravity. Aside from that, it may be helpful given the totality of multiple frames function together as self-supporting with the processing system. Thereby, expensive steel structures can be avoided given the combination of multiple frames as is necessary for related processing systems. In other words, this means that the moveable frames form the base support of the processing system or of a section of the processing system without the need for additional static components like supports or load-bearing elements. Designing the frames after the manner of a framework using tilted braces is preferable and the respective ends of the braces can be connected to each other at node points.

Dimensioning the frames for the processing system to the size of shipping containers or half-sized containers or so they can be arranged inside of a shipping container may provide for simple transportation of the frames. In this manner, all of the frames could be transported by means of a container transport vehicle, such as so-called tank containers, to the installation location for the processing system and also removed from there as needed. Skilled artisans should be well aware that “tank container” designates a container without side walls or roof. A tank container may be equipped with or without a front wall and has the standard size of customary ISO containers, whereby experts know that the acronym ISO indicates the International Organization for Standardization. Designing the frames to the sizes of shipping containers or half that size is preferable.

### BRIEF DESCRIPTION OF THE DRAWINGS

Additional details, characteristics and benefits of the present disclosure will be found in the following description of a preferred design example in connection with the sub-claims. In this, the respective characteristics may be implemented individually or in multiple combinations. The schematic of the design example has been depicted in the figures. Where the same reference numbers are used in the individual figures, they refer to the same or functional same corresponding elements based on their function.

The figures include:

FIG. 1 is an isometric view of one configuration of a processing system with multiple frames forming a processing system;

FIG. 2 is a side view of a collection module of one processing system in accordance with the present disclosure;

FIG. 3 is an isometric view of a metal removal module of one processing system in accordance with the present disclosure;

FIG. 4 is an isometric view of a preliminary separation module of one processing system in accordance with the present disclosure;

FIG. 5 is an isometric view of a scanning module of one processing system in accordance with the present disclosure;

FIG. 6 is an isometric view of a crushing module of one processing system in accordance with the present disclosure;

FIG. 7 is an isometric view of a classification module of one processing system in accordance with the present disclosure; and FIG. 8 is an isometric view of two granulated separation modules of a processing system in accordance with the present disclosure.

### DETAILED DESCRIPTION

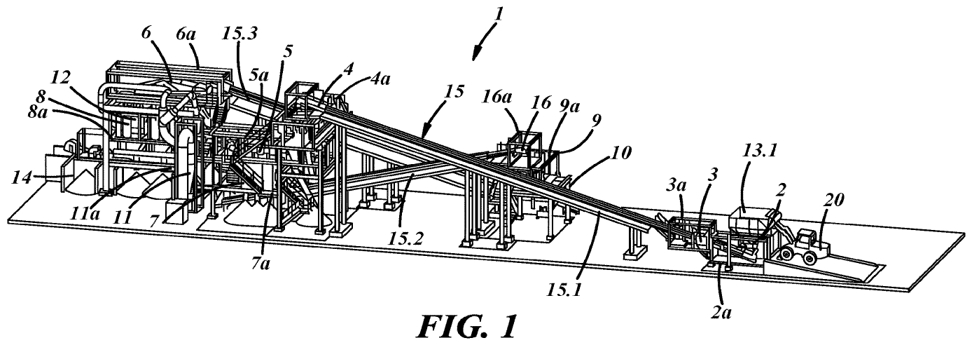

FIG. 1 depicts a processing system for the preparation of a mixture of old glass of various types, such as white, brown and green glass as well as undesirable foreign materials and contaminants. The processing system is constructed of the frames 2a, 3a, 4a, 5a, 6a, 7a, 8a, 9a, 11a, 16a and the conveyor system 15 connecting frames 1, 15, 2, 15.3. The dimensions of the frames correspond to the dimensions of shipping containers or tank containers or have been dimensioned, so that they can be arranged inside of a shipping container, so that the frame can be transported to the construction site in pre-assembled form for the creation of the processing system. The frames with the modules installed are arranged with each other for the construction site and connected with the conveyor system so that a functional processing system for mixtures of old glass can be constructed in a simple manner in the shortest possible time.

In the depicted design, the processing system includes a collection module 2 installed in the frame 2a, whereby a supply system has been arranged above the collection module as a filling funnel 13.1. The filling funnel 13.1 has been designed so that it can be filled by a conveyance vehicle 20, such as a wheel loader, with a mixture of old glass. From the collection module 2, the mixture of old glass will be transported to the ferrous metal module 3, which has been installed in the frame 3a. Ferrous metal components will be removed from the mixture of old class as part of the preliminary sorting in the ferrous metal module 3.

The mixture of old glass will then be moved to the preliminary separation module 4 in frame 4a by the conveyor system 15.1. Light organic material in particular will be separated and removed in the preliminary separation module 4 from the shards of the mixture of old glass. The remaining mixture of old glass will then be supplied to the scanning module 5 in frame 5a. Additional rough contaminants and waste materials will be removed manually from the mixture of old glass at this scanning module 5, which has been depicted as a manual workstation in the depicted design. Reduction of the remaining mixture of old glass follows in the subsequent crushing module 7 in frame 7a to the pre-defined shard size. The reduced mixture of old glass will be supplied to the metal removal module in frame 9a by the conveyor system 15.2, which is depicted as a conveyor belt or bucket conveyor and driven by the motor system 16 installed in frame 16a. Removal of non-ferrous metals as well as the ferrous metals remaining in the mixture of old glass after the initial ferrous metal separation will be done there. A label removal module 10 has been placed after the metal removal module 9, where both labels clinging to the shards as well as other remnants, especially organic materials will be removed.

The remaining mixture of old glass will be moved from the label removal module 10 to the classification module 6 installed in frame 6a by the conveyor belt 15.3. In the classification module 6, the mixture of old glass will go through various sieves, which will sort the material into various granular size groups and can remove the remaining foreign materials from the mixture of old glass. The mixture of old glass will be given to the granulated separation module 8 in frame 8a after the classification module. In this separation module, foreign materials such as ceramic, stone and porcelain materials will be removed by means of optical sorting. In addition, the granulated separation module 8 presents the possibility for removing heat-resistant glass, lead glass and ferrous metals The design example includes a color sorting module 12 as an helpful part of the granulated separation module, which has been installed in the granulated separation module 8 and frame 8a. The color sorting module allows the mixture of old glass to be sorted by color, in particular brown, green and white glass.

After processing, the individual components of the mixture of old glass will be stored in storage units 14 the design example presented in bunkers separated from each other so that the cleaned old glass corresponding to the requirements for melting for recycling can be removed from the storage equipment 14 in a simple manner. In addition, the foreign materials and waste removed from the mixture of old glass during processing will also be stored in separate storage units 14. To minimize the dust emissions from the processing system 1, a dust removal module 11 that is also pre-assembled and delivered to the installation site in a frame 11a has been provided. The fact that frames 2a, 3a, 4a, 5a, 6a, 7a, 8a, 9a, 11a & 16a can be arranged on floor plates or elevated depending on the type of installation. In addition, frames 2a, 3a, 4a, 5a, 6a, 7a, 8a, 9a, 11a & 16a can be designed to be stacked above each other and support themselves. To reduce dust emissions even further, frames 2a, 3a, 4a, 5a, 6a, 7a, 8a, 9a, 11a & 16a can be provided with exterior walls, which have not been depicted here for reasons of transparency.

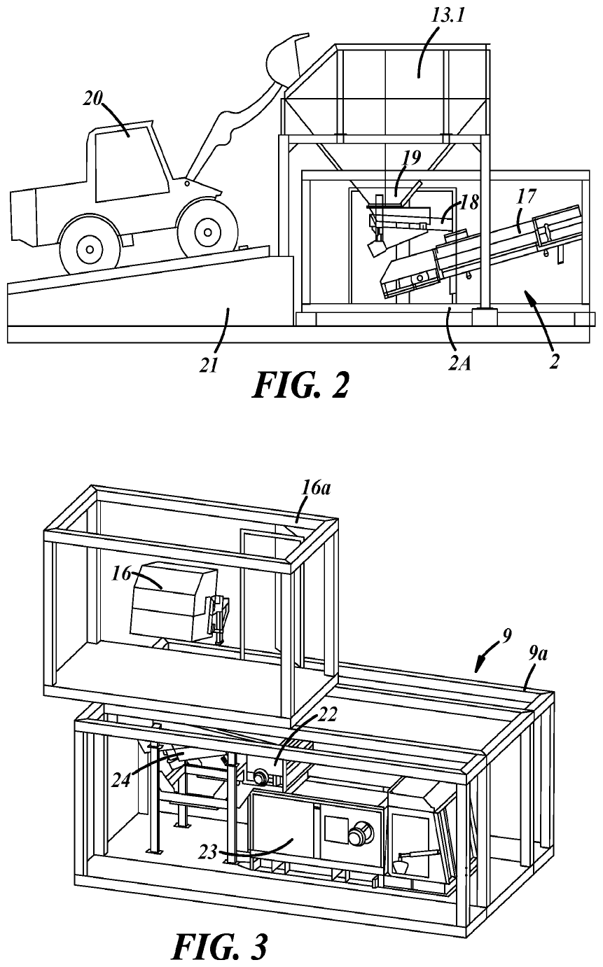

FIG. 2 depicts collection module 2 installed in frame 2a with a supply system 13, which has been designed as a filling funnel 13.1. Collection module 2 includes at least one discharge chute 18 for accepting the mixture of old glass. In addition, the lower funnel component 19 and a conveyor belt with a conveyor belt tensioning station 17 have been arranged in frame 2a in the depicted design example, which will supply the collected mixture of old glass to the discharge chute 18. The filling funnel 13.1 can be placed above frame 2a in a simple manner thanks to the provision of a lower funnel component 19 in frame 2a and become connected with the lower funnel component 19. In a simple manner, this creates a filling funnel that can be assembled at the installation site for the processing station 1, which allows a conveyance vehicle 20 to fill the processing station 1. As intended in the depicted design example, a drive ramp 21 can be created to provide access to the filling funnel 13.1 so that filling the filling funnel 13.1 become simple.

FIG. 3 should be understood as a metal removal module 9 and a motor system 16. The motor system 16 services to drive a conveyor system not depicted here, such as a conveyor belt, and has been installed in a separate frame 16a. This makes assembly of the motor system possible before delivery to the installation site for the processing system 1, so that only less complex conveyor components are created on site, such as the support construction. The metal removal module 9 has been installed in frame 9, whereby the metal removal module 9 depicted in this design example has a vibrating chute 24, a magnetic drum 22 for removing ferrous metal components and an alternating current precipitator 23 for removing non-ferrous metal component from the mixture of old glass.

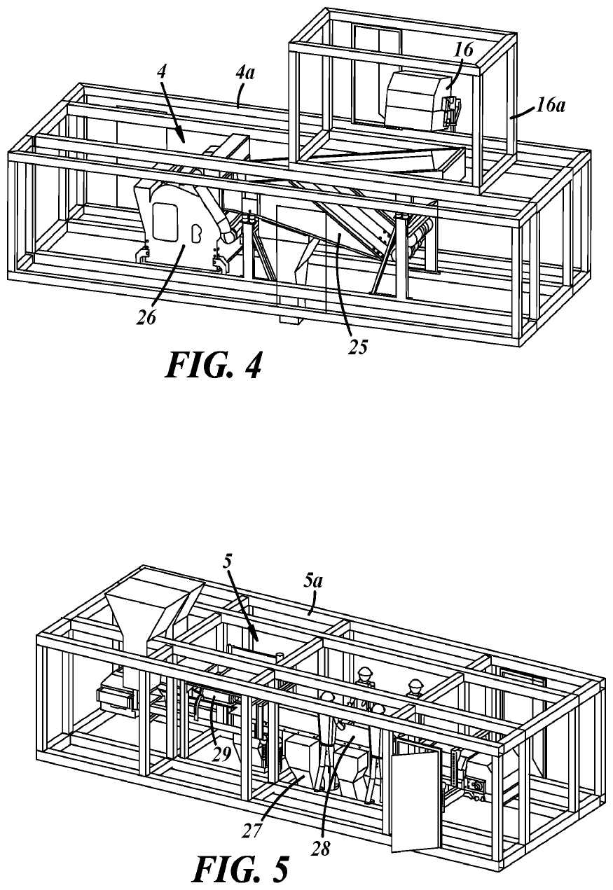

FIG. 4 depicts a frame 16a with a motor system 16 and a frame 4a, where a preliminary separation module 4 has been installed. The preliminary separation module 4 depicted in this design example includes at least one bulk goods sieve 25 for removing relatively large foreign materials in the old glass mixture and an organic removal device 26 for removing light organic materials in particular from the shards of the old glass mixture.

FIG. 5 depicts a scanning module 5 has been installed in the frame 5a. The figure shows that this scanning module 5 has a system for manually removing foreign materials from the mixture of old glass. The scanning belt 28 drive by the motor system will convey the glass mixture to the manual workstations so that foreign materials can be removed manually and disposed of through the waste chutes 27. A magnet 29 has been installed above the belt after the manual workstations will remove remaining metallic components from the mixture of old glass.

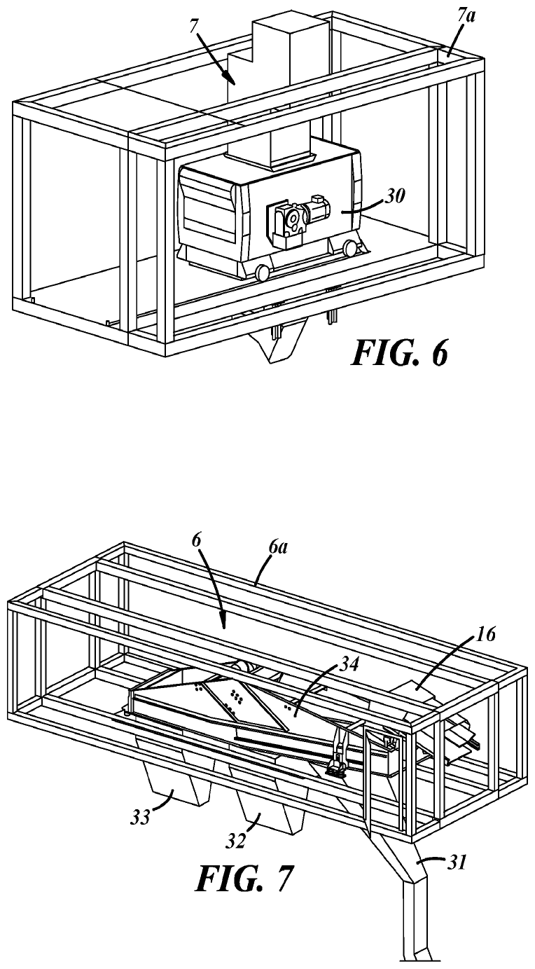

FIG. 6 depicts a dual-drum crusher 30, which has been installed in frame 7a as a component of the crushing module 7. The dual-drum crusher 30 will reduce the shards of the old glass mixture to a pre-defined size.

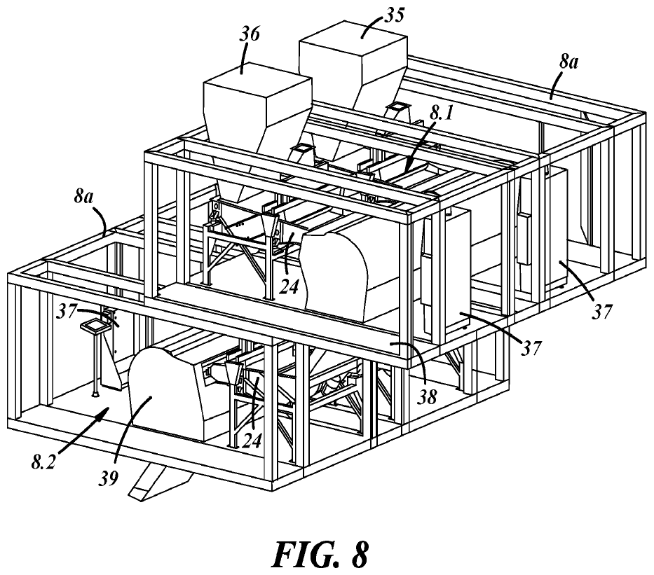

FIG. 7 depicts a frame 6a, where a classification module 6 has been installed. The mixture of old glass will be supplied to the classification module 6 using a conveyance system that has not been depicted here, whereby the conveyor system will be driven by the motor system 16. The mixture of old glass will be separated in the sieve system 34 according to groups, in this case a fine group, a small group and a large group. A fine group could include granule sizes of 0 to 8 mm; a small group, 8 to 24 mm; and a large group, granule sizes of 24 to 50 mm, for example. The fine group will be discharged by the fine chute 31; the small group, by the small chute 32; and the large group, by the large chute 33 and supplied either to a storage system 14 or a subsequent processing step.

FIG. 8 depicts two granulated separation modules 8.1 & 8.2, which have been respectively installed in frame 8a. A two-step separation process has been implemented in the depicted design example by stacking frames 8a so that that granulated separation modules 8.1 and 8.2 are arranged above each other. Granulated separation module 8.1 does the separation for the first step, while granulated separation module 8.2 does the separation for the second step. Granulated separation module 8.1 includes two three-way removal system 38, whereby one of the three-way sorting systems 38 is supplied with a small group through the small group intake 35 and a vibrating chute 24 and the other three-way sorting system 38 is supplied with a large group through the large group intake 36 and a vibrating chute 24. The three-way sorting systems 38 for granulated separation module 8.1 can be controlled by a control console 37.

The mixture of old glass is separated in the three-way sorting system as “gramber” (which is a mixture of green and brown, or amber, glass) and white glass as well as undesirable foreign materials, such as ceramic, stone and porcelain materials. In addition, other undesirable foreign materials, like heat-resistant glass, lead glass and metals, can be removed. The three-way sorting system 38 in the frame of the three-way sorting system will create groups, specifically green-brown glass, white glass and foreign materials and send them separately either to a storage system 14 or a subsequent processing step.

The white glass components of the old glass mixture will be sent from the granulated separation module 8.1 to the second separation step in granulated separation module 8.2 and supplied to a two-way sorting system 39 by a vibrating chute 24. The two-way sorting system 39 will also be controlled by a control console 37. The green and brown glass components will again be removed from the white glass group represented by granulated separation module 8.1 in the second step of separation in granulated separation module 8.2 due to the increased requirements placed on white glass for melting for recycling. Then, the white glass group separated in granulated separation module 8.2 will be sent to a storage system 14 not depicted here along with those from granulated separation module 8.2 and removed, The green and brown glass group will be sent to a different storage system. The two-step granulated separation modules 8. 1 and 8.2 regularly represent the conclusion of the processing procedure, such that there will be recyclable groups of old glass mixture after undergoing separation in granulated separation modules 8. 1 and 8.2, which can be supplied to a subsequent melting process for recycling.

1. A processing system for the preparation of a mixture of old glass with several modules, whereby the processing system comprising:
at least one collection module, in which the mixture of old glass can be placed and from which the mixture of old glass can be supplied to the processing system;
at least one ferrous metal module, in which ferrous metals can be removed from the mixture of old glass;
at least one preliminary separation module, in which light materials and rough components can be removed from the mixture of old glass, and at least one scanning module, in which solid materials can be removed from the mixture of old glass;
at least one classification module, in which the mixture of old glass can be separated into various groups;
at least one crushing module, in which glass components of the mixture of old glass can be reduced;
at least one granulate separation module, in which ceramic, stone and/or porcelain components can be removed from the mixture of old glass;
at least one metal removal module, in which non-ferrous metals can be removed from the mixture of old glass; and
at least one transportable frame, whereby one or more of the at least one collection module, the at least one ferrous metal module, the at least one preliminary separation module, the at least one scanning module, the at least one classification module, the at least one crushing module, the at least one granulate separation module, and/or the at least one metal removal module are installed in the frame.

2. The processing system set forth in claim 1, further comprising at least one label removal module.

3. The processing system set forth in claim 1, further comprising at least one dust removal module.

4. The processing system set forth in claim 1, further comprising at least one coloring sorting module, in which the glass components of the mixture of old glass can be sorted by color.

5. The processing system set forth in claim 4, wherein the color sorting module is installed in the granulate separation module, such that the ceramic, stone and/or porcelain components will be removed from the mixture of old glass and the glass components of the mixture of old glass will be sorted by color.

6. The processing system set forth in claim 1, further comprising an optical sorting system in the granulate separation module.

7. The processing system set forth in claim 1, wherein the processing system has two granulate separation modules, whereby the two granulate separation modules are arranged after each other in the flow of the mixture of old glass through the processing system.

8. The processing system set forth in claim 1, further comprising at least one supply system to supply the mixture of old glass to the collection module.

9. The processing system set forth in claim 8, wherein the supply system for supplying the mixture of old glass includes a filling funnel.

10. The processing system set forth in claim 9, wherein the filling funnel provides an interim storage of a minimal quantity of the mixture of old glass to the supply system.

11. The processing system set forth in claim 1, further comprising at least one storage system for storing at least one sorted component of the mixture of old glass.

12. The processing system set forth in claim 1, further comprising a conveyance system in connection with the modules.

13. The processing system set forth in claim 12, wherein the the conveyance system is arranged after the collection module to convey the mixture of old glass from the collection module to the ferrous metal module, after the ferrous metal module to convey the mixture of old glass from the ferrous metal module to the preliminary separation module, after the scanning module to convey the mixture of old glass from the scanning module to the metal removal module, and/or to convey the mixture of old glass to the classification module.

14. The processing system set forth in claim 12, further comprising at least one motor system in the frame for driving the conveyance system.

15. The processing system set forth in claim 1, wherein the frame is self-supporting.

16. The processing system set forth in claim 1, wherein the frame includes an enclosing exterior wall that encloses an interior in the frame against penetration by dust.

17. The processing system set forth in claim 1, wherein the processing system includes multiple transportable frames.

18. The processing system set forth in claim 17, wherein the multiple transportable frames are stacked above each other.
